(19) United States
(12) Patent Application Publication
(10) Pub. No.: US 2025/0083119 A1
(43) Pub. Date: Mar. 13, 2025

(54) REACTOR APPARATUS

(71) Applicant: Walter KANZLER, Graz (AT)

(72) Inventor: Walter KANZLER, Graz (AT)

(21) Appl. No.: 18/721,841

(22) PCT Filed: Dec. 15, 2022
(86) PCT No.: PCT/AT2022/060445

§ 371 Date: Jun. 19, 2024

(30) Foreign Application Priority Data
Dec. 20, 2021 (AT) A 51021/2021

(51) Int. Cl. B01J 19/18; B01J 19/00; C08J 11/12; C10B 47/14; C10B 47/18; C10B 53/07; C10B 57/02; C10K 1/18

(52) U.S. Cl. CPC B01J 19/1862; B01J 19/0013; B01J 19/006; B01J 19/0066; C08J 11/12; C10B 47/14; C10B 47/18; C10B 53/07; C10B 57/02; C10K 1/18; B01J 2219/00033; B01J 2219/0004; B01J 2219/00094; B01J 2219/00182; C10G 2300/1003

(57) ABSTRACT

A reactor apparatus for a continuous depolymerization of polymers, in particular polyolefins from polymer wastes, includes a primary reactor, further includes a heating unit for a heating and a melting and for an at least partial depolymerization of the polymers within the primary reactor, and includes at least one primary circulation unit for a circulation of molten polymers in the primary reactor, wherein the reactor apparatus comprises a secondary reactor, which is connected downstream of the primary reactor and forms a reactor cascade with the primary reactor.

### CROSS-REFERENCE TO RELATED APPLICATIONS

This patent application is a U.S. national stage application of international patent application PCT/AT2022/060445, filed on Dec. 15, 2022, which is based on and claims priority to Austrian patent application AT51021/2021A, filed on Dec. 20, 2021, the contents of which are incorporated herein by reference.

### PRIOR ART

The invention concerns a reactor apparatus, a depolymerization plant and a method for a continuous depolymerization of polymers.

As the waste volume of plastic waste, for example of packaging material, tires and the like, increases, the demand for efficient technologies for the utilization of such waste streams increases. Herein a purely material utilization of these waste streams to form equivalent products is not always economically possible or is often accompanied by downcycling, for example due to high demands of individual polymer groups being in an unmixed state. An efficient chemical utilization of the polymers contained in these waste streams for decomposition into their individual monomers or oligomers and/or mixtures of monomers and oligomers and/or mixtures of different hydrocarbon fractions, which are capable of replacing fossil hydrocarbons such as crude oil or natural gas, and the subsequent production of products of equal or higher value, for example fuels, is therefore desired. In addition to known methods for the chemical utilization of plastic waste, such as dry distillation, low-temperature carbonization or gasification of plastic waste, which, however, are often not economically feasible, methods for continuous depolymerization are increasingly also in the focus of research and development in the field of recycling technology.

A method for continuous depolymerization of polymers is already known from WO 2017/152205 A1. Herein a continuous process is described for the pyrolysis of polyethylene, polypropylene and polystyrene in a stirring apparatus with an external pump and heat exchanger at slight overpressure, wherein these polymers are indirectly heated, melted and partially depolymerized by means of a molten-salt system as heat transfer medium and are then to be forwarded to a downstream-connected, horizontally mounted tubular second reactor with stirring blades for complete evaporation. For the efficient performance of the method, however, a degree of depolymerization of greater than 90% would be required in the stirring apparatus in order to be able to efficiently process the remaining highly viscous residual fraction in the horizontally mounted tubular second reactor. However, since almost ideal mixing takes place in the stirring apparatus, the required degrees of depolymerization are scarcely achievable in practice and an efficient performance of this known method is therefore scarcely possible in practice.

The objective of the invention consists in particular in advantageously further developing a generic apparatus and a generic method with regard to efficiency. The objective is achieved according to the invention.

### Advantages of the Invention

The invention is based on a reactor apparatus for a continuous depolymerization of polymers, in particular polyolefins from polymer wastes, with a primary reactor vessel, with a heating unit for a heating and a melting and for an at least partial depolymerization of the polymers within the primary reactor, and with at least one primary circulation unit for a circulation of molten polymers in the primary reactor.

It is proposed that the reactor apparatus comprises a secondary reactor, which is connected downstream of the primary reactor and forms a reactor cascade with the primary reactor.

Such an implementation advantageously allows providing a reactor apparatus with improved efficiency. Since a secondary reactor is connected downstream of the primary reactor, a required degree of depolymerization of greater than 90% is advantageously achievable within the reactor cascade, and thus an efficient depolymerization is enabled. In combination with the molten-salt system already known from WO 2017/152205 A1 for indirect heat transfer in the primary reactor and the secondary reactor, efficiency can be advantageously improved further.

A “reactor apparatus” is to mean an, in particular functional, constituent, in particular a structural and/or functional component, of a depolymerization plant. The reactor apparatus may also comprise the entire depolymerization plant. The reactor apparatus and/or the depolymerization plant comprising the reactor apparatus is, without being limited thereto, configured for performing methods for a continuous depolymerization of polymers, in particular polyolefins, such as polyethylene, polypropylene and polystyrene. The reactor apparatus and/or the depolymerization plant preferably comprises a molten-salt system, as is already described in WO 2017/152205 A1. The molten-salt system is preferably configured for an operation with a molten salt, which consists substantially of potassium nitrate and/or sodium nitrate and/or potassium nitrite and/or sodium nitrite. The heating unit is preferably configured for indirect heat transfer via the molten-salt system.

The primary reactor is preferably configured as a primary stirring reactor. The secondary reactor is preferably configured as a secondary stirring reactor. Preferentially the secondary stirring reactor forms a stirring cascade together with the primary stirring reactor. The reactor apparatus may also comprise a tertiary reactor, which is connected downstream of the secondary reactor and which may be configured in particular analogously to the horizontally mounted, tubular second depolymerization reactor described in WO 2017/152205 A1. The tertiary reactor may form a reactor cascade with the primary reactor and the secondary reactor. The primary reactor and the secondary reactor are preferably configured as vertical reactors while the tertiary reactor is configured as a horizontal reactor. The primary reactor and the secondary reactor are configured for processing medium-viscous molten polymers while the tertiary reactor is configured for processing highly viscous molten polymers. The tertiary reactor is configured for receiving molten polymers which have been depolymerized to a fraction of greater than 90% in the primary reactor and the secondary reactor. In the tertiary reactor stirring arms are arranged, which are configured for throwing the molten highly viscous polymers in a uniformly distributing manner against the inner wall of the tertiary reactor, thus forming a thin layer. On an outer wall of the tertiary reactor, a tertiary heat exchanger is arranged, which is configured for further, in particular completely, depolymerizing the highly viscous molten polymers using the heat supplied via the outer wall. The stirring arms in the tertiary reactor must be distinguished from stirring members, as may be arranged in the primary reactor and/or the secondary reactor. In principle the reactor apparatus could comprise, in addition to the primary reactor and the secondary reactor, any number of further reactors, which in particular appears expedient to someone skilled in the art, said further reactors being connected downstream of the secondary reactor and upstream of the tertiary reactor and forming a reactor cascade together with the primary reactor and the secondary reactor.

In the present document, numerical words, such as for example “first” and “second”, which precede specific terms, serve merely to distinguish objects and/or to assign objects to one another, and do not imply any existing total number and/or ranking of the objects. In particular, a “second object” does not necessarily imply the presence of a “first object”.

In this document, “at least substantially” is to mean that a deviation from a given value is in particular less than 25%, preferably less than 10% and particularly preferentially less than 5% of the predetermined value.

“Configured” is to mean specifically designed and/or equipped. The fact that an object is configured for a specific function is to mean that the object fulfils and/or carries out this specific function in at least one application state and/or operation state.

It is further proposed that the reactor apparatus comprises a secondary circulation unit with at least one secondary circulation element for generating a radial flow within the secondary reactor. Such an implementation advantageously allows further increasing efficiency. In particular, improved circulation of the molten polymers and thus improved depolymerization in the secondary reactor is enabled. The secondary circulation unit comprises at least one secondary circulation element which may be embodied, for example, as a pump and is preferably embodied as a stirring element. The secondary circulation unit preferably comprises a plurality of secondary circulation elements embodied as stirring elements, which are arranged one above the other on a common stirring shaft.

In addition, it is proposed that in at least one operation state a plug flow is provided within the secondary reactor. In this way, an efficiency in the melting and depolymerization can be advantageously improved further. The apparatus preferably comprises a flow-generating unit which is configured to create the plug flow. The flow-generating unit comprises at least one inlet, which is arranged in an upper region of the secondary reactor, and at least one outlet, which is arranged in a lower region of the secondary reactor. The secondary reactor preferably has a tubular basic shape in order to further support providing of the plug flow. In principle it would be alternatively or additionally conceivable for a plug flow to be provided in the primary reactor.

It is further proposed that the primary circulation unit comprises at least one primary circulation element for generating an axial flow within the primary reactor. Such an implementation advantageously allows further improving efficiency. The primary circulation unit may comprise at least one primary circulation line. The primary circulation unit may comprise a plurality of primary circulation elements. At least one primary circulation element may be embodied as a pump configured to circulate a partial quantity of the molten polymers from the primary reactor via the circulation line. Preferably at least one primary circulation element is embodied as a stirring element.

It is also proposed that the primary reactor comprises an outlet unit for a feeding of a partial stream of the molten polymers into the secondary reactor, the outlet unit including an overflow region. Such an implementation advantageously enables selective feeding of the molten polymers from the primary reactor into the secondary reactor.

In addition, it is proposed that a height of the overflow region is variably adjustable for setting a residence time in the primary reactor. This advantageously allows improving flexibility. In particular, flexible adaption of a residence time distribution is enabled for different compositions of polymers that are to be depolymerized. Height adjustment is enabled, for example, by means of a plurality of overflow valves of the outlet unit which are arranged vertically one above the other in the overflow region.

Beyond this it is proposed that the primary reactor comprises at least one settling zone between a circulation region and the overflow region. In this way, efficient operation is advantageously enabled. In particular, an advantageous residence time distribution, and thus a high degree of depolymerization in the primary reactor, is attainable.

Furthermore, it is proposed that the reactor apparatus comprises a regulation unit, which is configured for regulating a filling level of molten polymers in the secondary reactor. In this way, particularly efficient and flexible operation is advantageously enabled. Preferably the regulation unit comprises at least one filling level indicator controller (LIC) and at least one regulation valve which is controllable via signals of the filling level indicator controller and is configured for controlling and/or regulating an outlet of molten polymers from the secondary reactor.

It is moreover proposed that the heating unit comprises at least one secondary heat exchanger, which is arranged outside the secondary reactor and is configured for heating the secondary reactor. In this way, efficient heat supply is advantageously made possible. Preferably, the secondary heat exchanger is configured as a shell heat exchanger and surrounds the secondary reactor along its circumferential direction. Preferably, the secondary heat exchanger is configured for operation via the molten-salt system of the depolymerization plant.

It is moreover proposed that the heating unit comprises at least one primary heat exchanger. In this way, efficient and gentle melting and heating as well as partial depolymerization of the polymers are advantageously enabled. Preferably, the primary heat exchanger is configured for operation via the molten-salt system of the depolymerization plant. In particular, the primary heat exchanger is configured for heating the polymers in the primary reactor to a first temperature, preferably between 250° C. and 350° C., and the secondary heat exchanger is configured for a heating of the polymers in the secondary reactor to a second temperature different from the first temperature, in particular higher than the first temperature, preferably between 380° C. and 500° C., preferentially between 420° C. and 480° C.

In a further aspect of the invention, which may in particular be considered both independently and in combination with other aspects of the invention, it is proposed that the reactor apparatus comprises a guide tube arranged within the primary reactor for a separation of two opposed axial flows in the primary reactor. Such an implementation advantageously enables efficient flow guidance in the primary reactor. In particular, already molten polymers may be conveyed in a first axial flow upwards within the guide tube and may be conveyed with further, newly added and not yet molten polymers in a second axial flow downwards outside the guide tube. Alternatively, a flow direction may also be reversed, wherein already molten polymers may be conveyed in a first axial flow downwards within the guide tube and upwards in a second axial flow outside the guide tube. Thus particularly efficient melting and depolymerization are enabled.

In addition, it is proposed that the primary heat exchanger at least partially surrounds the guide tube in a circumferential direction. By such an implementation improved heat transfer may advantageously be possible.

In a further aspect of the invention, which may in particular be considered both independently and in combination with other aspects of the invention, it is proposed that the reactor apparatus comprises a pretreatment reactor for a pretreatment of chlorine-containing polymers, which is connected upstream of the primary reactor and forms a reactor cascade with the primary reactor. By such an implementation, efficiency may advantageously be improved further. In particular, resource efficiency may be improved in that, in addition to polyolefins, chlorine-containing polymers, for example polyvinyl chloride and/or polyvinylidene chloride, can be depolymerized by means of the reactor apparatus. Furthermore, safety may advantageously be increased if chlorine-containing components are separated off in the pretreatment reactor, such that the formation of dangerous chlorine compounds, for example dioxins, which could be formed at higher temperatures in the primary reactor and/or the secondary reactor, is effectively prevented. Preferably the pretreatment reactor and components of the reactor apparatus which are arranged therein and/or are connected directly downstream of the pretreatment reactor, for example pipelines and the like, are made of corrosion-resistant materials, for example enamel and/or Hastelloy and/or titanium and/or zirconium and/or tantalum. The reactor apparatus is preferably configured for a single-stage pretreatment of chlorine-containing polymers in the pretreatment reactor. Alternatively, however, it would also be conceivable that the reactor apparatus is configured for a multi-stage pretreatment of chlorine-containing polymers and for this purpose includes a plurality of pretreatment reactors, which may in particular be arranged in a pretreatment cascade.

It is moreover proposed that the heating unit comprises at least one pretreatment heat exchanger for a heating and a melting and for an at least partial depolymerization of the chlorine-containing polymers. In this way, efficiency can be advantageously improved further. Preferably the pretreatment heat exchanger is configured for operation via the molten-salt system of the depolymerization plant.

It is further proposed that the reactor apparatus comprises a pretreatment circulation unit, which is arranged in the pretreatment reactor, for a circulation of molten chlorine-containing polymers. In this way, efficiency in the pretreatment can advantageously be improved further. The pretreatment circulation unit preferably comprises at least one stirring element. The pretreatment circulation unit may alternatively or additionally comprise at least one circulator pump.

It is further proposed that the reactor apparatus comprises a wet-separator unit, which is connected to the pretreatment reactor, for the aftertreatment of a gas phase arising in the pretreatment reactor. In this way, efficient aftertreatment of the gas phase arising in the pretreatment reactor is advantageously enabled. The wet-separator unit is preferably configured for aftertreatment by means of NaOH washing.

Beyond this, it is proposed that the reactor apparatus comprises a static mixer unit, which is arranged fluidically between the pretreatment reactor and the primary reactor, for separating off residual quantities of chlorine from a liquid phase arising in the pretreatment reactor. This advantageously allows further improving efficiency and safety of the reactor apparatus. In particular, material and/or cost efficiency can be improved if residual quantities of chlorine are completely separated off before entering the primary reactor, since the primary reactor and pipelines and plant parts of the depolymerization plant which are connected downstream of the primary reactor may advantageously be produced from less high-grade and therefore more cost-effective materials as corrosion resistance requirements are correspondingly lower. The static mixer unit preferably comprises at least one static mixer, which is configured for adding calcium oxide and for converting the residual quantities of chlorine into calcium chloride.

The invention further concerns a depolymerization plant with a reactor apparatus according to one of the above-described implementations and with at least one rectification column for the further treatment of gaseous depolymerization products arising in the primary reactor and/or in the secondary reactor. Such a depolymerization plant excels in particular by its advantageous properties with regard to efficiency, which are in particular achievable by the reactor apparatus. In addition to the reactor apparatus and the rectification column, the depolymerization plant may comprise further units and elements, in particular suitable pipelines, a heat exchanger for the condensation of products arising in gaseous form in the rectification column, and the like. The depolymerization plant is realized differently from a steam cracker.

The invention is furthermore based on a method for a continuous depolymerization of polymers by means of the above-described depolymerization plant, wherein polymers are fed to the primary reactor, are heated, melted and at least partially depolymerized in the primary reactor with circulation by means of the primary circulation unit and with heat supply by the heating unit, wherein gaseous depolymerization products arising in the primary reactor are fed to a rectification in the rectification column.

It is proposed that at least a partial stream of molten polymers is fed to the secondary reactor and is further depolymerized with heat being supplied by the heating unit, wherein depolymerization products arising in the secondary reactor are fed to the rectification in the rectification unit. By such a method, particularly efficient continuous depolymerization of polymers is advantageously enabled. Heating, melting and depolymerization of the polymers may advantageously take place without a liquid and/or gaseous auxiliary phase. The depolymerization is preferably carried out, in particular in contrast to the so-called steam cracker process, without steam being fed in.

It is further proposed that bottom products arising in the rectification column are fed to the secondary reactor and/or to the primary reactor. This advantageously allows further improving an efficiency of the method. In particular, a product yield may be increased if bottom products arising in the rectification column are fed to the secondary reactor and/or to the primary reactor.

In an advantageous implementation it is proposed that the method comprises a pretreatment step, in which chlorine-containing polymers are pretreated before being fed into the primary reactor and chlorine-containing components are separated off in the process. In this way, efficiency of the method can be advantageously improved further as chlorine-containing polymers can be used.

The reactor apparatus according to the invention, the depolymerization plant according to the invention and the method according to the invention shall here not be limited to the above-described application and implementation. In particular, in order to fulfil a functionality that is described here, the reactor apparatus according to the invention and/or the depolymerization plant according to the invention may comprise a number of individual elements, components and units that differs from a number given here.

### DRAWINGS

Further advantages emerge from the following description of the drawings. Four exemplary embodiments of the invention are illustrated in the drawings. The drawings, the description and the claims contain numerous features in combination. Someone skilled in the art will purposefully also consider the features individually and will find further expedient combinations.

In the drawings:

FIG. 1 shows a schematic piping and instrumentation flow diagram of a depolymerization plant with a reactor apparatus for a continuous depolymerization of polymers,

FIG. 2 shows a schematic pipeline and instrumentation flow diagram of a depolymerization plant with a reactor apparatus for a continuous depolymerization of polymers in a further exemplary embodiment,

FIG. 3 shows a further exemplary embodiment of a reactor apparatus for a continuous depolymerization of polymers with a primary reactor in a schematic representation,

FIG. 4 shows a schematic piping and instrumentation flow diagram of a depolymerization plant with a reactor apparatus for a continuous depolymerization of polymers in a further exemplary embodiment, and

FIG. 5 shows a schematic method flow chart for illustrating a method for a continuous depolymerization of polymers.

### DESCRIPTION OF THE EXEMPLARY EMBODIMENTS

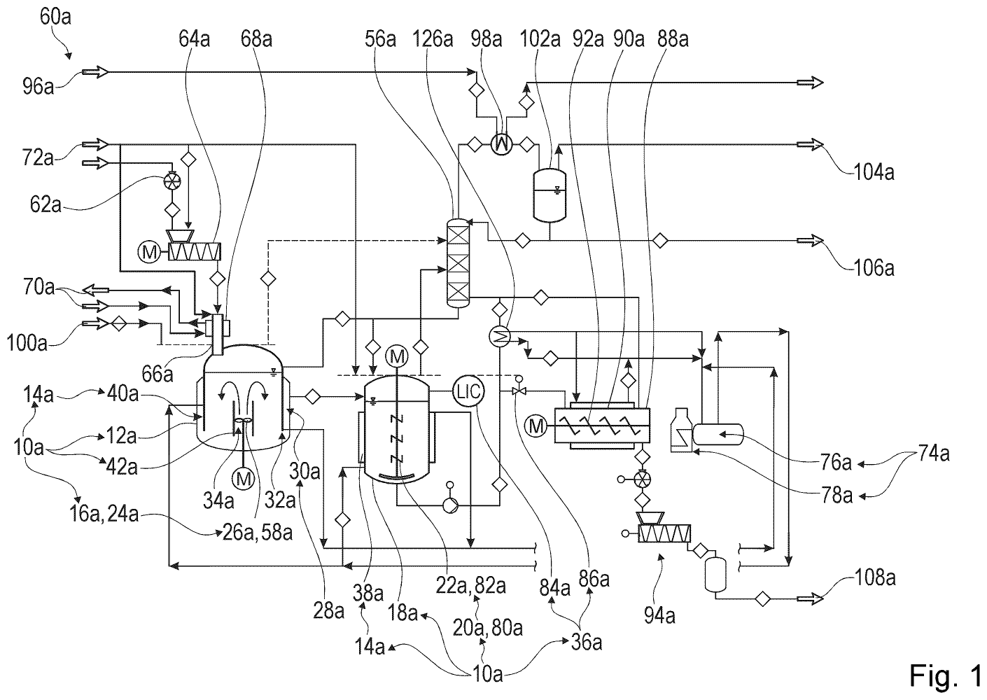

FIG. 1 shows a schematic piping and instrumentation flow diagram of a depolymerization plant 60a. The depolymerization plant 60a comprises a reactor apparatus 10a for a continuous depolymerization of polymers, in particular for the depolymerization of polyolefins, for example polyethylene and/or polypropylene and/or polystyrene, from polymer wastes (not shown).

The depolymerization plant 60a comprises a rotary valve 62a, a conveyor screw 64a and an inlet 66a. The inlet 66a comprises a cooling section 68a, which is connected to a cooling-water cycle 70a.

The reactor apparatus 10a comprises a primary reactor 12a. The primary reactor 12a is connected to the inlet 66a. For an operation of the depolymerization plant 60a polymer wastes, for example from big bags, can be fed to the primary reactor 12a via the rotary valve 62a with simultaneous supply of nitrogen as inert gas from a nitrogen supply line 72a by means of the conveyor screw 64a via the inlet 66a. The cooling section 68a herein prevents premature melting of the polymer wastes and thus blockage of the inlet 66a.

The reactor apparatus 10a further comprises a heating unit 14a for a heating and a melting and for an at least partial depolymerization of the polymers within the primary reactor 12a. The heating unit 14a comprises at least one primary heat exchanger 40a.

The reactor apparatus 10a comprises a guide tube 42a. The guide tube 42a is arranged within the primary reactor 12a and is configured for separating two opposed axial flows in the primary reactor 12a. The primary heat exchanger 40a is realized as a shell heat exchanger and is arranged on an outer side of the primary reactor.

A molten salt is used as a heat carrier medium for the operation of the primary heat exchanger 40a. The depolymerization plant 60a comprises a molten-salt system 74a with a molten-salt tank 76a and a heating device 78a, for example a melting furnace or the like. The molten salt, which consists essentially of potassium nitrate and/or sodium nitrate and/or potassium nitrite and/or sodium nitrite, is conveyed by means of a submersible pump (not shown) from the molten-salt tank 76a via suitable pipelines to the primary heat exchanger 40a and from there back into the molten-salt tank 76a.

The reactor apparatus 10a further comprises a primary circulation unit 16a. The primary circulation unit 16a is configured for a circulation of molten polymers in the primary reactor 12a. The primary circulation unit 16a comprises at least one primary circulation element 26a for generating an axial flow within the primary reactor 12a. In the present case, the primary circulation unit 16a is realized as a primary stirring unit 24a. The primary circulation element 26a of the primary circulation unit 16a is realized as a primary stirring element 58a. The primary circulation element 26a realized as a primary stirring element 58a is arranged in a circulation region 34a of the primary reactor 12a, namely within the guide tube 42a.

In an operation state of the reactor apparatus 10a, molten polymers are brought into a first axial flow upwards within the guide tube 42a by means of the primary stirring element 58a. Above the guide tube 42a, the molten polymers flow downwards, in a second axial flow outside the guide tube 42a, together with further polymer wastes added via the inlet 66a, wherein the further polymer wastes are melted by the primary heat exchanger 40a. During this process, the molten polymers are partially depolymerized. Alternatively, a reverse flow direction would also be conceivable, wherein molten polymers are brought into a first axial flow downwards within the guide tube 42a by means of the primary stirring element 58a and rise again in a second axial flow upwards outside the guide tube.

The depolymerization plant 60a comprises a rectification column 56a. The primary reactor 12a is connected to the rectification column 56a. Gaseous depolymerization products arising within the primary reactor 12a in the operation state are fed to a first stage of the rectification column 56a.

The reactor apparatus 10a comprises a secondary reactor 18a. The secondary reactor 18a is connected downstream of the primary reactor 12a and forms a reactor cascade with the primary reactor 12a.

The primary reactor 12a comprises an outlet unit 28a for feeding a partial stream of the molten polymers into the secondary reactor 18a. The outlet unit 28a comprises an overflow region 30a. The primary reactor 12a comprises at least one settling zone 32a. The settling zone 32a is arranged between the circulation region 34a and the overflow region 30a. In the operation state, the partial stream of the polymers molten in the primary reactor 12a passes via the settling zone 32a into the overflow region 30a and is transferred from there into the secondary reactor 18a.

The reactor apparatus 10a comprises a secondary circulation unit 20a with at least one secondary circulation element 22a for creating a radial flow within the secondary reactor 18a. In the present case, the secondary circulation unit 20a is realized as a secondary stirring unit 80a. The secondary circulation element 22a of the secondary circulation unit 20a is embodied as a secondary stirring element 82a. In the present case, the secondary circulation unit 20a comprises several secondary circulation elements 22a, which are embodied as secondary stirring elements 82a and are connected vertically one above the other one to a stirring axis. For the sake of clarity, in FIG. 1 only one of the secondary circulation elements 22a has been given a reference numeral.

The heating unit 14a comprises at least one secondary heat exchanger 38a. The secondary heat exchanger 38a is arranged outside the secondary reactor 18a. The secondary heat exchanger 38a is configured for a heating of the secondary reactor 18a. In the present case, the secondary heat exchanger 38a is realized as a shell heat exchanger and is arranged in a circumferential direction around the secondary reactor 18a. The secondary heat exchanger 38a is fed via the molten-salt system 74a. In FIG. 1 the molten-salt system 74a is illustrated in a simplified manner for the sake of clarity. Preferably the molten-salt system 74a comprises two separate molten-salt cycles for supplying the primary heat exchanger 40a and the secondary heat exchanger 38a such that the polymers in the primary reactor 12 and in the secondary reactor 18 can be heated to different temperatures. In the operation state, the molten polymers are fed from the primary reactor 12a into the secondary reactor 18a in an upper region and are drawn out in a lower region. When passing the secondary reactor 18a, the polymers are moved outwards to the container wall by the radial flow generated by means of the secondary circulation elements 22a and are herein further heated by the secondary heat exchanger 38a. Gaseous depolymerization products arising herein rise upwards and are fed to a second stage of the rectification column 56a.

The reactor apparatus 10a comprises a tertiary reactor 88a, which is connected downstream of the secondary reactor 18a. The tertiary reactor 88a is horizontally mounted and is provided with stirring arms 92a.

In the operation state, a plug flow is provided within the secondary reactor 18a. Polymers that have not yet been depolymerized sink slowly downwards in the secondary reactor 18a and are fed to the tertiary reactor 88a. The reactor apparatus 10a comprises a regulation unit 36a. The plug flow is provided by means of the regulation unit 36a. The regulation unit 36a is configured for regulating a filling level of molten polymers in the secondary reactor 18a. The regulation unit 36a comprises a filling level indicator controller 84a and a regulation valve 86a. The regulation valve 86a is controlled via the filling level indicator controller 84a. A connecting line connects an outlet in the lower region of the secondary reactor 18a to the tertiary reactor 88a. Polymers are withdrawn from the secondary reactor 18a via the outlet by means of a pump and are partially directly transferred into the tertiary reactor 88a when the regulation valve 86a is open. Moreover, a heat exchanger 126a connected to the salt cycle 74a is arranged at the connecting line. A partial stream or—if the regulation valve 86a is closed—the total amount of the polymers drawn from the secondary reactor 18a, is further heated via the heat exchanger 126a, wherein arising gaseous depolymerization products are fed to a third stage of the rectification column 56a and a remaining liquid phase is fed to the tertiary reactor. The heating unit 14a comprises a tertiary heat exchanger 90a, which is arranged as a shell heat exchanger on an outer side of the tertiary reactor 88a and is fed via the molten-salt system 74a. By means of the stirring arms 92a, the molten polymers are thrown in a uniformly distributing manner against the inner wall of the tertiary reactor 88a while forming a thin layer, and are further depolymerized by the heat supplied via the tertiary heat exchanger 90a. Gaseous depolymerization products arising in the tertiary reactor 88a are fed to the third stage of the rectification column 56a. A remaining residual quantity of carbon black and inorganic constituents is fed to a disposal unit 94a and is discharged from there as a residual fraction 108a. Products generated in the rectification column 56a, which arise in gaseous form at the top of the rectification column 56a, are partially condensed by means of a heat exchanger 98a and are fed to a container 102a. The depolymerization products can be recovered from the container 102a in the form of a gaseous lightweight fraction 104a and in the form of a liquid heavyweight fraction 106a. Some of the products, in particular from the lightweight fraction 104a, can be used, for example, for the operation of the heating device 78a of the molten-salt cycle 74a. The heat exchanger 98a is operated by means of a hot-water cycle 96a. The rectification column 56a is fed via a diesel feed 100a. Alternatively or additionally, it is also conceivable that the rectification column 56a is fed via the heavyweight fraction 106a. Bottom products arising in the rectification column 56a can in turn be fed to the secondary reactor 18a and/or to the primary reactor 12a.

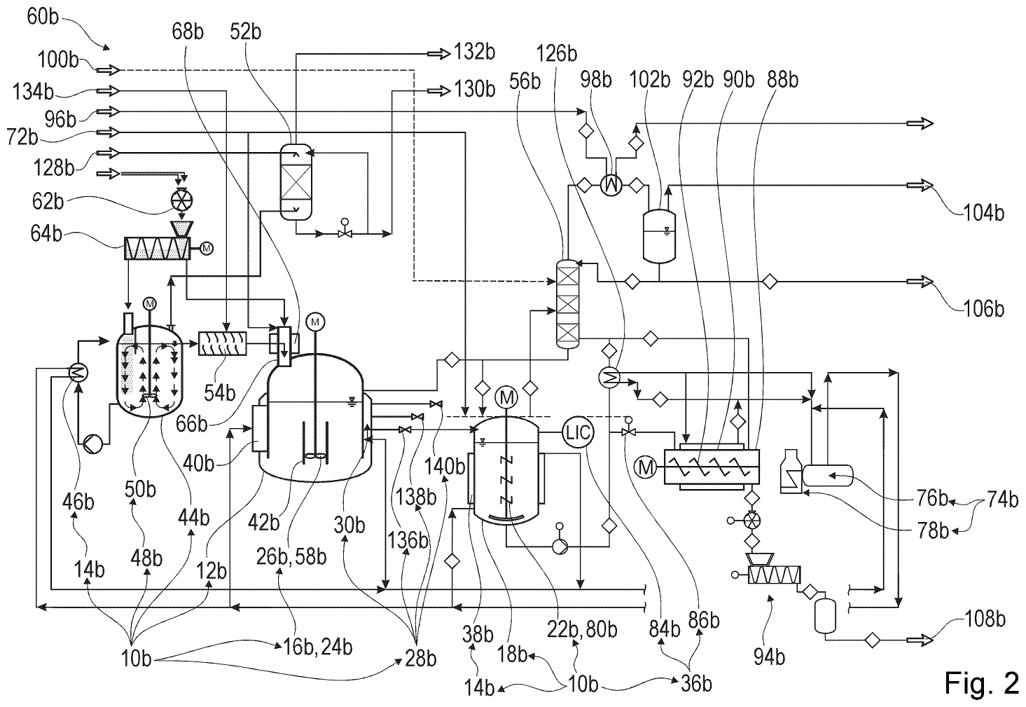

Three further exemplary embodiments of the invention are shown in FIGS. 2 to 4. The following descriptions and the drawings are substantially limited to the differences between the exemplary embodiments, wherein regarding components having the same designation, in particular components having the same reference numerals, reference may in principle also be made to the drawings and/or the description of the other exemplary embodiments, in particular of FIG. 1. To distinguish between the exemplary embodiments, the letter a has been added to the reference numerals of the exemplary embodiment in FIG. 1. In the exemplary embodiments of FIGS. 2 to 4, the letter a has been replaced by the letters b to d.

FIG. 2 shows a further exemplary embodiment of a depolymerization plant 60b with a reactor apparatus 10b for a continuous depolymerization of polymers in a schematic piping and instrumentation flow diagram.

In addition to a depolymerization of polyolefins such as polyethylene and/or polypropylene and/or polystyrene, the reactor apparatus 10b is also configured for a depolymerization of chlorine-containing polymers, for example polyvinyl chloride.

Analogously to the preceding exemplary embodiment, the reactor apparatus 10b comprises a primary reactor 12b, a secondary reactor 18b and a tertiary reactor 88b. The reactor apparatus 10b further comprises a pretreatment reactor 44b for the pretreatment of chlorine-containing polymers. The pretreatment reactor 44b is connected upstream of the primary reactor 12b and forms a reactor cascade with the primary reactor 12b.

The reactor apparatus 10b comprises a heating unit 14b which, analogously to the preceding exemplary embodiment, is fed via a molten-salt system 74b. The heating unit 14b comprises at least one pretreatment heat exchanger 46b for a heating and a melting and for an at least partial depolymerization of the chlorine-containing polymers. In FIG. 2 the molten-salt system 74b is illustrated in a simplified manner for the sake of clarity. Preferably, the molten-salt system 74b comprises three separate molten-salt cycles (not illustrated), namely a first molten-salt cycle for supplying a primary heat exchanger 40b for heating the primary reactor 12b, a second molten-salt cycle for supplying a secondary heat exchanger 38b for heating a secondary reactor 18b, and a third molten-salt cycle for supplying the pretreatment heat exchanger 46b such that the polymers in the pretreatment reactor 44b, the primary reactor 12 and the secondary reactor 18 can be heated to respectively different temperatures. In principle it would also be conceivable that only one single molten-salt cycle is used which, starting from a molten-salt tank, is conducted first via the secondary heat exchanger 38b, then via the primary heat exchanger 40b and then via the pretreatment heat exchanger 46b such that the polymers can be heated in the pretreatment reactor 44b, the primary reactor 12 and the secondary reactor 18 to respectively different temperatures.

The reactor apparatus 10b comprises a pretreatment circulation unit 48b, which is arranged in the pretreatment reactor 44b, for a circulation of molten chlorine-containing polymers. The pretreatment circulation unit 48b comprises a pretreatment circulation element 50b, which is embodied as a stirring element.

The reactor apparatus 10b comprises a wet-separator unit 52b, which is connected to the pretreatment reactor 44b, for the aftertreatment of a gas phase arising in the pretreatment reactor 44b. The wet-separator unit 52b is configured for NaOH washing of hydrochloric acid from the gas phase arising in the pretreatment reactor 44b and is supplied via a sodium hydroxide feed 128b. Sodium chloride-containing water, arising in the wet-separator unit 52b during the NaOH washing In an operation state of the reactor apparatus 10b, can be recovered as a sodium chloride fraction 130b. Waste gases arising are discharged as a waste gas fraction 132b.

The reactor apparatus 10b comprises a static mixer unit 54b, which is arranged fluidically between the pretreatment reactor 44b and the primary reactor 12b, for separating off residual amounts of chlorine from a liquid phase arising in the pretreatment reactor 44b. The liquid phase arising in the pretreatment reactor 44b in the operation state is fed to the static mixer unit 54b, wherein in the static mixer unit 54b calcium oxide is fed in via a calcium oxide feed 134b in order to convert chlorine-containing constituents remaining in the liquid phase into calcium chloride. Molten polymers freed from chlorine-containing constituents are fed to the primary reactor 12b.

Regarding the functionality of the primary reactor 12b, reference may largely be made to the above description of the preceding exemplary embodiment. The primary reactor 12b comprises an outlet unit 28b for feeding a partial stream of the molten polymers into a secondary reactor 18b, which is connected downstream of the primary reactor 12b. The outlet unit 28b comprises an overflow region 30b. In contrast to the preceding exemplary embodiment, a height of the overflow region 30b is variably adjustable for setting a residence time in the primary reactor 12b. For this purpose, the outlet unit 28b comprises a first overflow valve 136b, a second overflow valve 138b arranged above the first overflow valve 136b and a third overflow valve 140b arranged above the second overflow valve 138b. Depending on via which of the overflow valves 136b, 138b, 140b the overflow region 30b is connected to the secondary reactor 18b, a residence time in the primary reactor 12b can be adjusted variably in order to allow a flexible response to different compositions of polymer starting substances.

A further difference of the primary reactor 12b to the primary reactor 12a of the preceding exemplary embodiment consists in that a stirring shaft for driving a primary circulation element 26b of a primary circulation unit 16b, which is realized as a primary stirring element 58b, is introduced from above into the primary reactor 12b, while a stirring shaft of the primary stirring element 58a in FIG. 1 is inserted into the primary reactor 12a from below.

Regarding the further components and the functionality of the depolymerization plant 60b, reference may otherwise be made to the above explanations of the preceding exemplary embodiment.

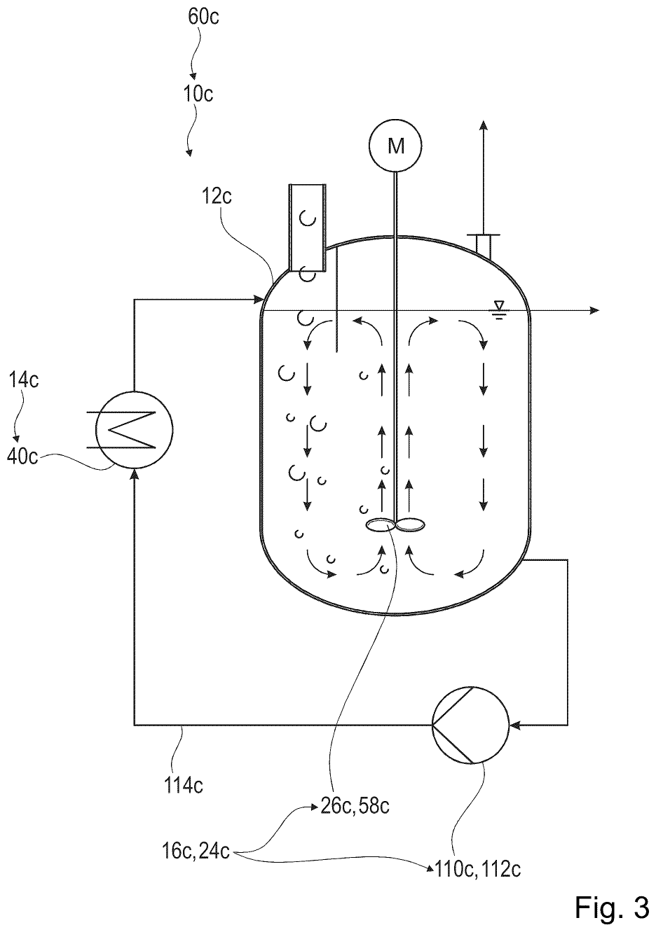

FIG. 3 shows a primary reactor 12c of a reactor apparatus 10c for a continuous depolymerization of polymers in a schematic representation. In contrast to the primary reactors 12a and 12b of the preceding exemplary embodiments, the primary reactor 12c is realized without a guide tube.

The reactor apparatus 10c comprises a primary circulation unit 16c. The primary circulation unit 16c is configured for a circulation of molten polymers in the primary reactor 12c. The primary circulation unit 16c comprises at least one primary circulation element 26c for creating an axial flow within the primary reactor 12c. Analogously to the preceding exemplary embodiment, the primary circulation unit 16c is realized as a primary stirring unit 24c and comprises a primary circulation element 26c that is embodied as a primary stirring element 58c. The primary circulation unit 16c comprises a further primary circulation element 110c. The further primary circulation element 110c is realized as a circulator pump 112c. In principle it would be conceivable that the primary stirring element 58c is dispensed with and the primary reactor 12c is operated exclusively with the circulator pump 112c.

The reactor apparatus 10c comprises a heating unit 14c for a heating and a melting and for an at least partial depolymerization of polymers within the primary reactor 12c. The heating unit 14c comprises at least one primary heat exchanger 40c. The primary heat exchanger 40c is arranged outside the primary reactor 12c on a circulation line 114c of the primary reactor 12c.

In an operation state of the reactor apparatus 10c, molten polymers can be sucked out of a lower region of the primary reactor 12c via the circulation line 114c by means of the circulator pump 112c, can be heated further by means of the primary heat exchanger 40c and can be fed back into the primary reactor 12c in an upper region. Alternatively, a reverse pumping direction through the circulation line 114c would also be conceivable.

In principle the secondary reactors 18a, 18b shown in the preceding exemplary embodiments and/or the pre-treatment reactor 44b of the second exemplary embodiment could also be realized analogously to the primary reactor 12c shown in this exemplary embodiment and could comprise the features described above with reference to the primary reactor 12c.

The reactor apparatus 10c is part of a depolymerization plant 60c and comprises a secondary reactor (not shown), which is connected downstream of the primary reactor 12c and forms a reactor cascade with the primary reactor 12c. With the exception of the differences concerning the primary reactor 12c, with regard to the implementation of the depolymerization plant 60c reference may be made to the above descriptions of the depolymerization plant 60a or the depolymerization plant 60b of the preceding exemplary embodiments.

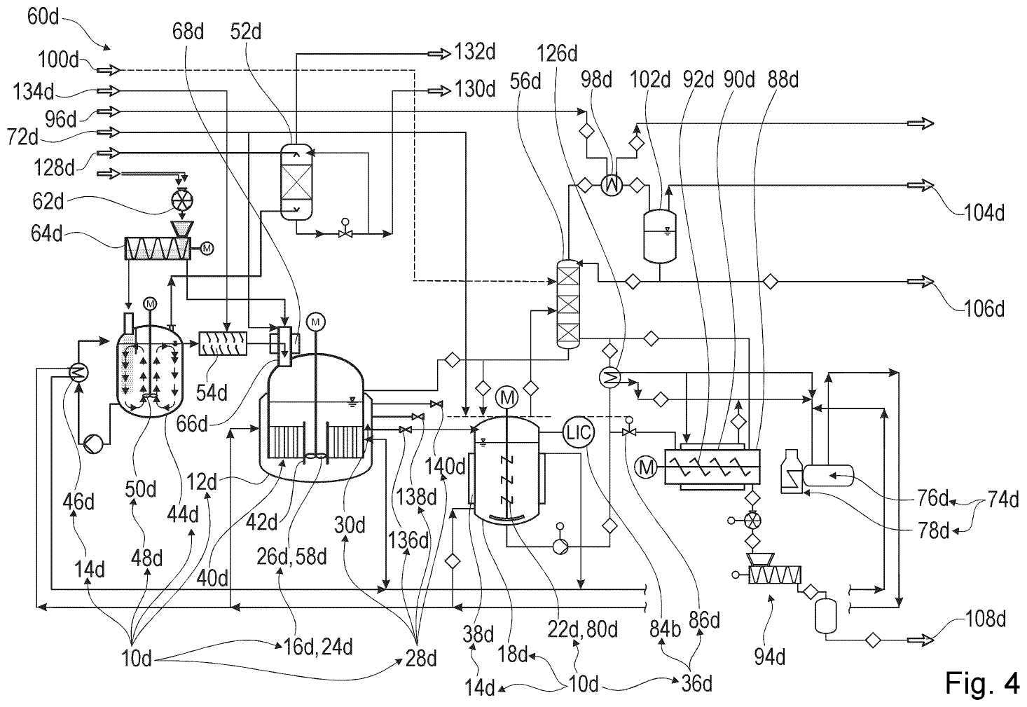

FIG. 4 shows a further exemplary embodiment of a depolymerization plant 60d with a reactor apparatus 10d for a continuous depolymerization of polymers in a schematic piping and instrumentation flow diagram.

The depolymerization plant 60d differs from the depolymerization plant 60b of the second exemplary embodiment regarding an implementation of a primary reactor 14d of the reactor apparatus 10d. The reactor apparatus 14d comprises a heating unit 14d with a primary heat exchanger 40d. The reactor apparatus 10d further comprises a guide tube 42d, which is configured for separating two opposed axial flows in the primary reactor 14d. Differently than in the preceding exemplary embodiments, the primary heat exchanger 40d is arranged within the primary reactor 14d and at least partially surrounds the guide tube 42d in a circumferential direction. The primary heat exchanger 40d is realized as a shell-and-tube heat exchanger and comprises a plurality of tubes with flow channels (not provided with a reference numeral) arranged therebetween.

The reactor apparatus 10d further comprises a primary circulation unit 16d. The primary circulation unit 16d is configured for a circulation of molten polymers in the primary reactor 12d. Analogously to the preceding exemplary embodiments, the primary circulation unit 16d comprises at least one primary circulation element 26d for creating an axial flow within the primary reactor 12d. In the present case, the primary circulation unit 16d is realized as a primary stirring unit 24d. The primary circulation element 26d of the primary circulation unit 16d is realized as a primary stirring element 58d and is arranged within the guide tube 42d.

In an operation state of the reactor apparatus 10d, molten polymers can be brought into a first axial flow upwards within the guide tube 42d by means of the primary stirring element 58d. Above the guide tube 42d, the molten polymers flow downwards, together with further polymer wastes added via the inlet 66d, in a second axial flow outside the guide tube 42d, through the flow channels between the tubes of the primary heat exchanger, wherein the further polymer wastes are melted by the primary heat exchanger 40d. During this process, the molten polymers are partially depolymerized.

The reactor apparatus 10d comprises a pretreatment reactor 44d for the pretreatment of chlorine-containing polymers. The pretreatment reactor 44d is connected upstream of the primary reactor 12d and forms a reactor cascade with the primary reactor 12d. The heating unit 14d comprises at least one pretreatment heat exchanger 46d for a heating and a melting and for an at least partial depolymerization of the chlorine-containing polymers. In the present case, the pretreatment reactor 44d is realized analogously to the exemplary embodiment in FIG. 2. Alternatively, however, it would also be conceivable for the reactor apparatus 10d to comprise a further guide tube (not illustrated) arranged in the pretreatment reactor 44d. It is moreover conceivable that the pretreatment heat exchanger 46d is arranged within the pretreatment reactor 44d and surrounds the further guide tube in a circumferential direction, such that the pretreatment reactor 44d is realized so as to be substantially identical to the primary reactor 10d.

Regarding the further components and the functionality of the depolymerization plant 60d, reference may otherwise be made to the above explanations of the exemplary embodiment of FIG. 2.

In principle further combinations of the features described with reference to the preceding exemplary embodiments are conceivable. For example, a primary reactor and a secondary reactor and/or a pretreatment reactor could be realized so as to be substantially identical to one another, or features which were described above with reference to one reactor could analogously be transferred to one or more of the other reactors.

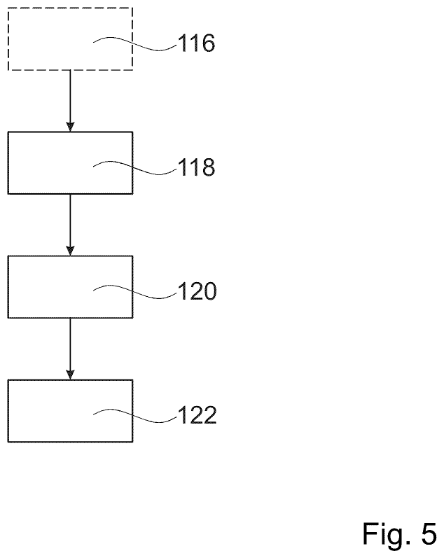

FIG. 5 shows a schematic method flow chart for illustrating a method for a continuous depolymerization of polymers by means of a depolymerization plant, wherein the depolymerization plant 60a, the depolymerization plant 60b or the depolymerization plant 60c or the depolymerization plant 60d of the preceding exemplary embodiments may be used for carrying out the method.

The method comprises at least three method steps. In a first method step 118 of the method, polymers, in particular in the form of polymer wastes, are fed to the primary reactor 12a, 12b, 12c, 12d. In the primary reactor 12a, 12b, 12c, 12d, the polymers are heated, melted and at least partially depolymerized with circulation by means of the primary circulation unit 24a, 24b, 24c, 24d and with heat supply by the heating unit 14a, 14b, 14c, 14d, wherein gaseous depolymerization products arising in the process are fed to a rectification in the rectification column 56a, 56b, 56d. Preferably the polymers are heated in the first method step 118 to a temperature between 250° C. and 350° C., particularly preferentially to 300° C. In a second method step 120 of the method, at least a partial stream of molten polymers is fed to the secondary reactor 18a, 18b, 18d and is further depolymerized with heat supply by the heating unit 14a, 14b, 14c, 14d, wherein gaseous depolymerization products arising in the process are fed to the rectification column 56a, 56b, 56d. Preferably the partial stream is heated in the second method step 120 to a temperature between 380° C. and 500° C., particularly preferentially between 420° C. and 480° C. In a third method step 122 of the method, the constituents from the secondary reactor 18a, 18b that have not yet been depolymerized in the method steps 118, 120 are fed to the tertiary reactor 88a, 88b, 88d either directly or via the heat exchanger 126a, 126b, 126d for further depolymerization. Gaseous depolymerization products arising in the feeding to the tertiary reactor 88a, 88b and/or arising in the tertiary reactor 88a, 88b are fed to the rectification column 56a, 56b in the third method step 122. At the same time as the method steps 118, 120, 122, the rectification of the gaseous depolymerization products takes place in the rectification column 56a, 56b, 56d, wherein bottom products arising in the rectification column 56a, 56b are fed to the secondary reactor 18a, 18b, 18d and/or to the primary reactor 12a, 12b, 12c, 12d. After subsequent partial condensation of the products that arise at the top of the rectification column 56a, 56b, 56d, these are partially condensed via the heat exchanger 98a. After this, the lightweight fraction 104a, 104b, 104d and the heavyweight fraction 106a, 106b, 106d can be recovered.

For a processing of chlorine-containing polymers, the method may comprise an optional pretreatment step 116, which is arranged upstream of the first method step 118. In the pretreatment step 116, chlorine-containing polymers are pretreated before being fed into the primary reactor 12a, 12b, 12c, 12d and chlorine-containing components are separated off in the process.

The pretreatment step 116 is preferably realized by means of the pretreatment reactor 44b described in the second exemplary embodiment or by means of the pretreatment reactor 44d described in the fourth exemplary embodiment and by means of the static mixer unit 54b or the mixer unit 54d connected thereto. The chlorine-containing polymers are heated, melted and at least partially depolymerized in the pretreatment reactor 44b, 44d by means of the pretreatment heat exchanger 46b, 46d. Aftertreatment of the gas phase arising in the pretreatment reactor 44b, 44d is realized by NaOH washing in the wet-separator unit 52b, 52d. The liquid phase arising is fed to the static mixer unit 54b, 54d, wherein residual chlorine fractions are converted into calcium chloride in the static mixer unit 54b, 54d by adding calcium oxide. The molten polymers freed from chlorine-containing constituents are fed to the primary reactor 12b, 12d, where the first method step 118 is then carried out.

1. A reactor apparatus for a continuous depolymerization of polymers, in particular polyolefins from polymer wastes, with a primary reactor, with a heating unit for a heating and a melting and for an at least partial depolymerization of the polymers within the primary reactor, and with at least one primary circulation unit for a circulation of molten polymers in the primary reactor, comprising a secondary reactor, which is connected downstream of the primary reactor and forms a reactor cascade with the primary reactor.

2. The reactor apparatus according to claim 1, comprising a secondary circulation unit with at least one secondary circulation element for creating a radial flow within the secondary reactor.

3. The reactor apparatus according to claim 1, wherein in at least one operation state a plug flow is provided within the secondary reactor.

4. The reactor apparatus according to claim 1, wherein the primary circulation unit comprises at least one primary circulation element for creating an axial flow within the primary reactor.

5. The reactor apparatus according to claim 1, wherein the primary reactor comprises an outlet unit for a feeding of a partial stream of the molten polymers into the secondary reactor, the outlet unit including an overflow region.

6. The reactor apparatus according to claim 5, wherein a height of the overflow region is variably adjustable for setting a residence time in the primary reactor.

7. The reactor apparatus according to claim 5, wherein the primary reactor comprises at least one settling zone between a circulation region and the overflow region.

8. The reactor apparatus according to claim 1, comprising a regulation unit, which is configured for a regulation of a filling level of molten polymers in the secondary reactor.

9. The reactor apparatus according to claim 1, wherein the heating unit comprises at least one secondary heat exchanger, which is arranged outside the secondary reactor and is configured for heating the secondary reactor.

10. The reactor apparatus according to claim 1, wherein the heating unit comprises at least one primary heat exchanger.

11. The reactor apparatus according to claim 1, comprising a guide tube arranged within the primary reactor for a separation of two opposed axial flows in the primary reactor.

12. The reactor apparatus according to claim 11, wherein the heating unit comprises at least one primary heat exchanger, and wherein the primary heat exchanger at least partially surrounds the guide tube in a circumferential direction.

13. The reactor apparatus at least according to claim 1, comprising a pretreatment reactor for a pretreatment of chlorine-containing polymers, which is connected upstream of the primary reactor and forms a reactor cascade with the primary reactor.

14. The reactor apparatus according to claim 13, wherein the heating unit comprises at least one pretreatment heat exchanger for a heating and a melting and for an at least partial depolymerization of the chlorine-containing polymers.

15. The reactor apparatus according to claim 13, comprising a pretreatment circulation unit, which is arranged in the pretreatment reactor, for a circulation of molten chlorine-containing polymers.

16. The reactor apparatus according to claim 13, comprising a wet-separator unit, which is connected to the pretreatment reactor, for the aftertreatment of a gas phase arising in the pretreatment reactor.

17. The reactor apparatus according to claim 13, comprising a static mixer unit, which is arranged fluidically between the pretreatment reactor and the primary reactor, for separating off residual amounts of chlorine from a liquid phase arising in the pretreatment reactor.

18. A depolymerization plant with a reactor apparatus according to claim 1 and with at least one rectification column for a further treatment of gaseous depolymerization products arising in the primary reactor and/or in the secondary reactor.

19. A method for a continuous depolymerization of polymers by means of a depolymerization plant according to claim 18, wherein polymers are fed to the primary reactor, are heated, melted and at least partially depolymerized in the primary reactor with circulation by means of the primary circulation unit and with heat supply by the heating unit, wherein gaseous depolymerization products arising in the primary reactor are fed to a rectification in the rectification column, wherein at least a partial stream of molten polymers is fed to the secondary reactor and is further depolymerized with heat being supplied by the heating unit, wherein gaseous depolymerization products arising in the secondary reactor are fed to the rectification in the rectification column.

20. The method according to claim 19, wherein bottom products arising in the rectification column are fed to the secondary reactor and/or to the primary reactor.

21. The method according to claim 19, comprising a pretreatment step, in which chlorine-containing polymers are pretreated before being fed into the primary reactor and chlorine-containing components are separated off in the process.

22. A reactor apparatus for a continuous depolymerization of polymers, in particular polyolefins from polymer wastes, with a primary reactor, with a heating unit for a heating and a melting and for an at least partial depolymerization of the polymers within the primary reactor, and with at least one primary circulation unit for a circulation of molten polymers in the primary reactor, comprising a guide tube arranged within the primary reactor for a separation of two opposed axial flows in the primary reactor.

23. A reactor apparatus for a continuous depolymerization of polymers, in particular polyolefins from polymer wastes, with a primary reactor, with a heating unit for a heating and a melting and for an at least partial depolymerization of the polymers within the primary reactor, and with at least one primary circulation unit for a circulation of molten polymers in the primary reactor, comprising a pretreatment reactor for a pretreatment of chlorine-containing polymers, which is connected upstream of the primary reactor and forms a reactor cascade with the primary reactor.
